(19) United States
(12) Patent Application Publication
(10) Pub. No.: US 2016/0185300 A1
(43) Pub. Date: Jun. 30, 2016

(54) VEHICLE PILLAR TRIM PANEL WITH STORAGE COMPARTMENT

(71) Applicant: FORD GLOBAL TECHNOLOGIES, LLC, Dearborn, MI (US)

(72) Inventors: Kathleen M. Parlow, Columbus, MI (US); Nicholas Alphonse Billardello, Macomb, MI (US)

(21) Appl. No.: 14/584,378

(22) Filed: Dec. 29, 2014

(51) Int. Cl. B60R 7/04; B60R 13/02

(52) U.S. Cl. CPC B60R 7/04; B60R 13/025; B60R 2013/0287

(57) ABSTRACT

A vehicle trim assembly is provided. The vehicle trim assembly includes a trim panel. A recessed storage compartment is provided in the trim panel. A flexible cover overlies the storage compartment. An expandable sidewall connects the flexible cover to the trim panel.

### TECHNICAL FIELD

This document relates generally to interior trim components for a motor vehicle and, more particularly, to a vehicle pillar trim panel incorporating a recessed, expandable storage compartment.

### BACKGROUND

Motor vehicle users are always looking for convenient places to store and hold personal items such as wallets, cell phones, electronics, flashlights, sports equipment such as golf balls, suntan lotion, eye drops and the like. In many cases the typical storage options designed into motor vehicles, including, for example, glove boxes, console bins, console cup holders, instrument panel, center stack storage compartments, door map pockets, seatback pockets and the like either do not provide enough dedicated storage or are simply not versatile enough to provide the best possible option. Further, these dedicated storage options are typically fixed and non-configurable to best meet the needs of the user. Further, most are focused upon storage within reach of the driver or front row passenger and are not conveniently available to rear seat occupants. As a result it is clear that a need exists for additional storage options in the interior trim of a motor vehicle.

### SUMMARY

In accordance with the purposes and benefits described herein, a vehicle trim assembly is provided. That vehicle trim assembly comprises a trim panel, a recessed storage compartment in the trim panel, a flexible cover overlying the storage compartment and an expandable sidewall connecting the flexible cover to the trim panel. Such a trim assembly is particularly suited for the C and/or D pillars of the motor vehicle that are readily accessible to second and third row vehicle occupants. In addition such a trim panel would be readily accessible to consumers from outside the vehicle through door and liftgate openings.

In one possible embodiment, the recessed storage compartment includes a stepped sidewall forming a depressed lip. The flexible cover includes a substrate defining an outer margin of the cover. The outer margin is received and supported on that lip when the flexible cover is in a closed position whereby the cover is supported flush with the trim panel overlying the recessed storage compartment.

In one possible embodiment, the substrate includes four sides and defines an open framework. The first side has multiple heat stakes that anchor the substrate/cover to the face panel. Two sidewalls extend from the first side and include a living hinge adjacent the first side. The expandable sidewall extends from the substrate sidewalls to the trim panel.

In addition, the substrate includes an open side connecting the sidewalls of the substrate opposite the first side. The open side is void of any expandable sidewall and provides an opening to the recessed storage compartment. A band of elastic material connects the cover to the trim panel adjacent the open side. When the cover is opened, the elastic band biases the cover toward the closed position so that the flexible cover holds and hugs any object held in the storage compartment thereby preventing it from shifting and rattling.

A flexible covering material is stretched across the open framework formed by the substrate. In one possible embodiment, that covering material is vinyl. In one possible embodiment, that covering material is leather. In one possible embodiment, that covering material is cloth. In one possible embodiment that covering material is a combination of two or more of vinyl, leather and cloth.

In one possible embodiment, a slot is provided in the pillar trim panel adjacent the open side of the cover. The slot communicates with the recessed storage compartment and provides a good point for one to engage the cover with a finger to pull the cover open. In one possible embodiment, the recessed storage compartment and cover are trapezoidal in shape. Further, the open side of the cover/storage compartment is oriented toward a rear of the vehicle.

In the following description, there are shown and described several preferred embodiments of the vehicle trim assembly. As it should be realized, the vehicle trim assembly is capable of other, different embodiments and its several details are capable of modification in various, obvious aspects all without departing from the vehicle trim assembly as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the vehicle trim assembly and together with the description serve to explain certain principles thereof. In the drawing figures:

FIG. 1 is a perspective view of the vehicle trim assembly showing the flexible cover in the closed position overlying the recessed storage compartment.

FIG. 2 is a schematic cross-sectional view showing the flexible cover in the closed position wherein the cover is supported flush with the trim panel on the stepped sidewall of the recessed storage compartment which forms a depressed lip.

FIG. 3 is a perspective view illustrating the flexible cover in the open position wherein the recessed storage compartment or pocket is expanded to hold, for example, the illustrated cell phone.

FIG. 4 is a schematic cross-sectional view illustrating the vehicle trim assembly with the flexible cover in the open position and the expandable sidewalls of the recessed storage compartment partially expanded to hold various items (not shown).

FIG. 5a is a detailed rear elevational view of the substrate that defines an open framework and the perimeter of the cover.

FIG. 5b is a front elevational view showing how the substrate of the cover is received on the depressed lip of the recessed storage compartment.

FIG. 5c is a cross-section along line 5c-5c of FIG. 5b illustrating the elastic band that connects the substrate of the cover to the recessed storage compartment in the trim panel.

Reference will now be made in detail to the present preferred embodiments of the vehicle trim assembly, examples of which are illustrated in the accompanying drawing figures.

### DETAILED DESCRIPTION

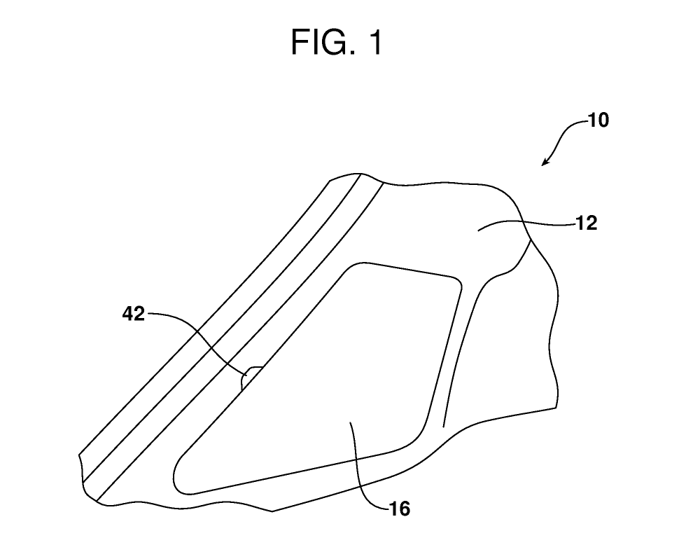

Reference is now made to FIGS. 1-5c illustrating the vehicle trim assembly 10. Such a vehicle trim assembly 10 may be utilized anywhere in the vehicle and is particularly useful on the A, B, C or D pillar of a motor vehicle. Significantly, the C and D pillars provide a convenient and accessible storage space for personal items for those in the two rear seat rows of a motor vehicle. In addition, such a pillar trim panel would be readily accessible to consumers from outside the vehicle through door and liftgate openings.

As illustrated, the vehicle trim assembly 10 includes a pillar trim panel 12 that covers the metal superstructure of the vehicle pillar (not shown). A recessed storage compartment or pocket 14 is provided in the pillar trim panel 12. A cover assembly 16 overlies the storage compartment. An expandable sidewall 18 connects the cover assembly 16 to the pillar trim panel 12 in a manner that will be described in greater detail below.

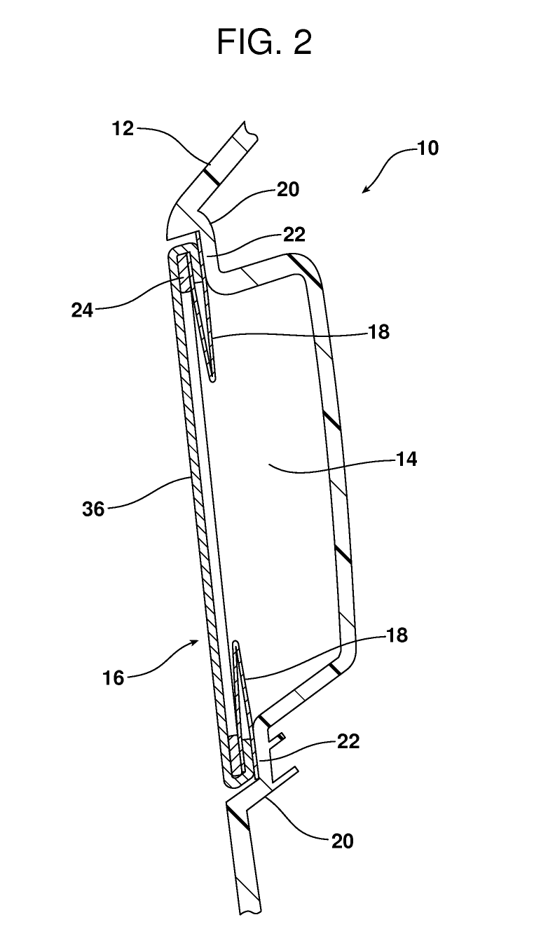

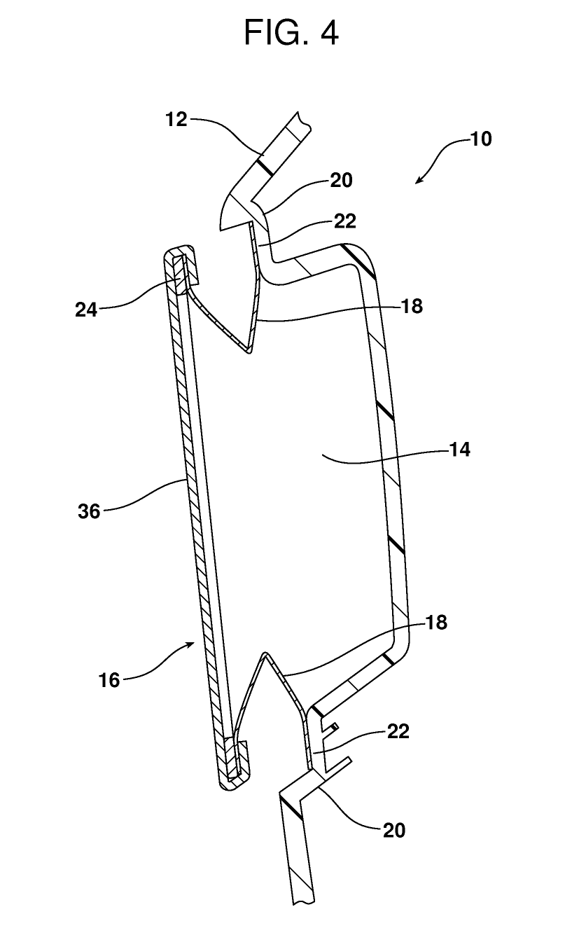

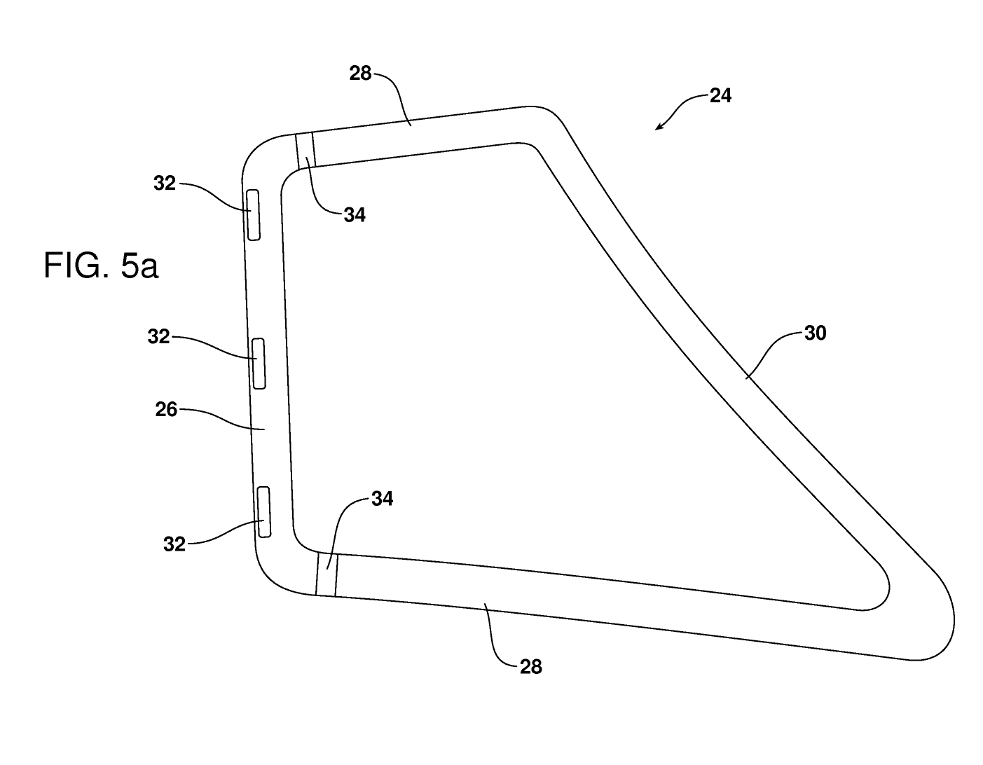

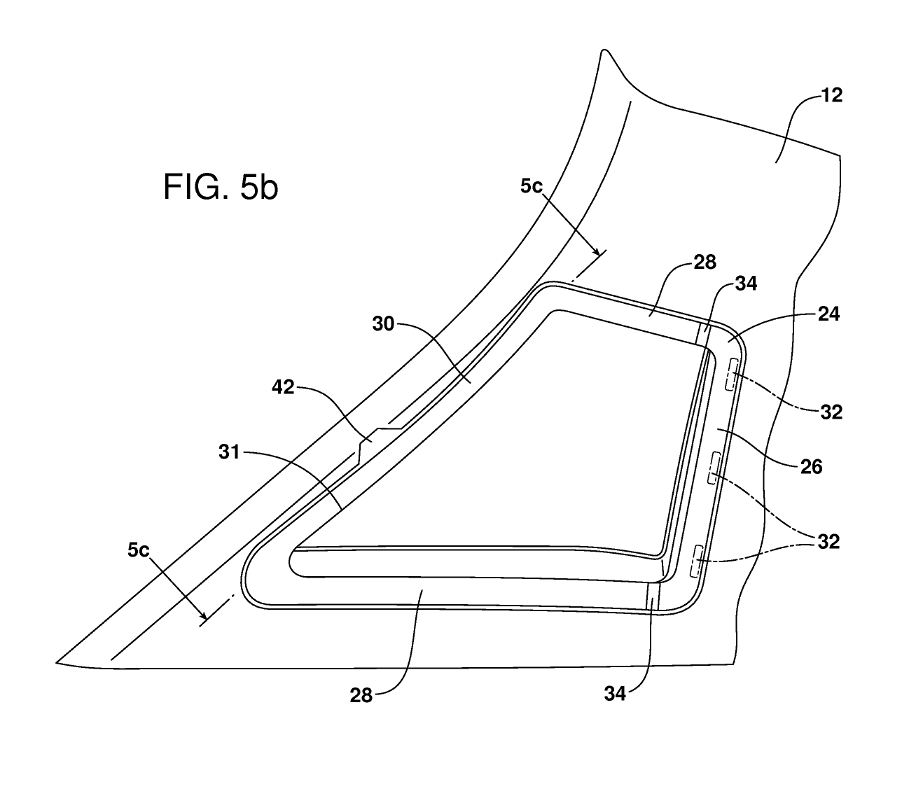

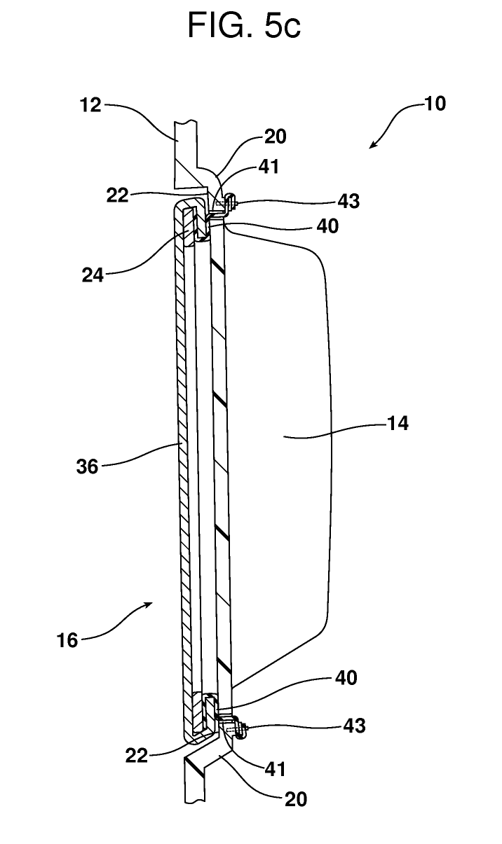

As best illustrated in FIGS. 2 and 4, the recessed storage compartment 14 includes a stepped sidewall 20 and a depressed lip 22 that extends continuously around the recessed storage compartment 14. As best illustrated in FIGS. 1, 5a and 5b the cover assembly 16 includes a substrate 24 that forms an open framework and the outer margin of the cover assembly 16. More specifically, the substrate 24 includes a first wall 26, two sidewalls 28 connected to the first wall and an open side 30 connected to the two sidewalls opposite the first wall. Together the four sides 26, 28 and 30 form an open framework having a central opening 31.

Multiple heat stakes 32 are integrally molded on the first wall 26 and secure the substrate 24 of the cover assembly 16 to the trim panel 12. In addition, a living hinge 34 is provided in the two sidewalls 28 adjacent the first wall 26. The living hinge 34 allows the cover assembly 16 to pivot or hinge open.

A flexible cover material 36 is stretched across the substrate 24 over the opening 31 to complete the cover assembly 16. The flexible cover material 36 may be selected from a group of materials including, but not necessarily limited to, vinyl, leather, cloth and combinations thereof.

This flexible cover material 36 may be directly secured to the stepped sidewall 20 and/or depressed lip 22 along the first sidewall 26, to the right of the living hinge 34 in drawing FIG. 5b. The expandable sidewall 18 connects the substrate sidewalls 28 to the stepped sidewall 20 and/or recessed lip 22 of the recessed storage compartment 14 between the living hinge 34 and the open side 30 of the substrate 24. The expandable sidewall 18 may incorporate a pleated construction as illustrated. Preferably the expandable sidewall 18 is made from a durable, light weight material that has been treated to return to its pleated state when not expanded.

A band of elastic material 40 connects each sidewall 28 of the substrate 24 to the pillar trim panel 12 at the recessed storage compartment 14 adjacent the open side 30. This band 40 may, for example, be about 1.26 cm wide. The band 40 may be secured by adhesive, heat staking or some other appropriate means to the substrate sidewalls 28 and the pillar trim panel 12. In the illustrated embodiment, the band 40 extends through aperture 41 in the pillar trim panel 12 and is secured to the B-side by staples 43. The band 40 may also be sown, embossed or otherwise connected to an end of the expandable sidewall 18 to provide a continuous storage pouch with the cover assembly 16 and the recessed compartment 14.

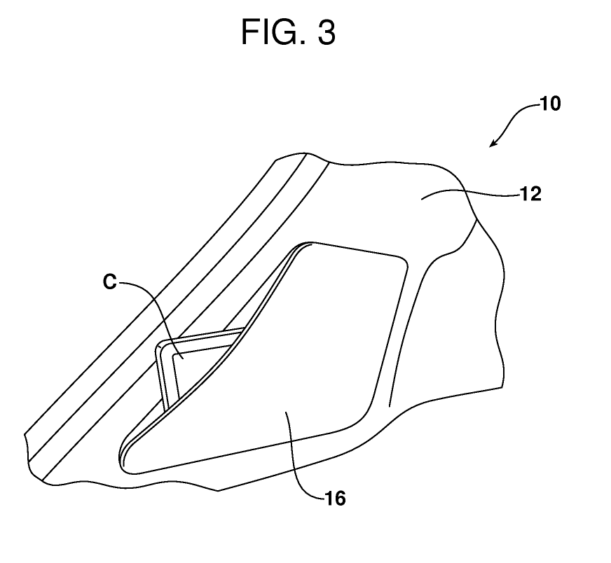

A slot 42 is provided in the trim panel 12 adjacent the open side 30. The slot 42 communicates with the recessed storage compartment 14 and provides a convenient point for one to engage the cover assembly 16 with the fingers and pivot the cover open about the living hinge 34 against the biasing force of the elastic band 40. As the cover assembly 16 is opened to gain access to the recessed storage compartment 14 through the open side 30, the expandable sidewalls 18 expand. One can then insert items such as the cell phone C illustrated in FIG. 3 into the storage compartment 14. Upon releasing the cover assembly 16, the elastic band 40 biases the cover about the living hinge 34 toward the closed position. Thus, the cover assembly 16 tends to positively hold and hug items held in the storage compartment or pouch 14, preventing them from shifting and rattling.

Whenever the storage compartment 14 is later emptied of items, the elastic band 40 draws the cover assembly 16 fully closed so that the pleated, expandable sidewall 18 rests along the stepped sidewall 20 and the substrate 24 is supported on the depressed lip 22 with the outer surface of the cover flush with the outer surface of the trim panel 12 (see FIGS. 1 and 2). Thus, when closed, the trim panel assembly 10 has a smooth and aesthetically pleasing appearance.

In the illustrated embodiment, the recessed storage compartment 14 and cover assembly 16 are both trapezoidal in shape with the open side 30 oriented toward the rear of the motor vehicle. In the illustrated embodiment, the parallel sides of the trapezoid define the upper and lower sides of the recessed storage compartment 14. Thus, the living hinge 34 is oriented toward the front of the motor vehicle.

In summary, the vehicle trim assembly 10 with the integrated recessed storage compartment 14 and cover assembly 16 with the expandable sidewall 18 provides a number of benefits. The soft, flexible and compliant cover assembly 16 with the elastic band 40 snugly and securely holds personal items at a pillar of a vehicle where they may be conveniently accessed and positively held in position. When not in use, the elastic band 40 snugly pulls the cover assembly 16 against the recessed lip 22 of the storage compartment 14 so that the cover fits flush 16 with the pillar trim panel 12 to provide an aesthetically pleasing appearance.

The foregoing has been presented for purposes of illustration and description. It is not intended to be exhaustive or to limit the embodiments to the precise form, shape or location disclosed. Obvious modifications and variations are possible in light of the above teachings. For example, in the illustrated embodiment the open side 30 of the cover assembly 16 is oriented rearwardly in the vehicle. Certainly other orientations are possible including, for example, upwardly. Further, while a pillar trim assembly 10 is illustrated in detail, it should be appreciated that the trim assembly may be provided at other locations, including but not necessarily limited to the hard trim (quarter, cowl, console valence panels, hard seat backs, lids such as console armrest lids or glove box lids and the like). All such modifications and variations are within the scope of the appended claims when interpreted in accordance with the breadth to which they are fairly, legally and equitably entitled.

1. A vehicle trim assembly, comprising:
a trim panel;
a recessed storage compartment in said trim panel;
a flexible cover including a substrate overlying said storage compartment, wherein said substrate includes a living hinge; and
an expandable sidewall connecting said cover to said trim panel.

2. The assembly of claim 1, wherein said recessed storage compartment includes a stepped sidewall forming a depressed lip.

3. The assembly of claim 2, wherein said substrate defining an outer margin of said cover, said outer margin being received by and supported upon said lip when said cover is in a closed position whereby said cover is supported flush with said trim panel overlying said recessed storage compartment.

4. (canceled)

5. The assembly of claim 3, wherein said cover includes one open side void of any sidewall, said open side being at an end of said cover opposite said living hinge.

6. The assembly of claim 5, wherein said expandable sidewall extends between said open side and said living hinge.

7. The assembly of claim 5, wherein said substrate forms an open framework and said cover includes a flexible covering material stretched across said framework.

8. The assembly of claim 7, further including a band of elastic material connecting said cover to said trim panel adjacent said open side, whereby when said flexible cover is displaced from said closed position to an open position to expand said storage compartment, said elastic band biases said flexible cover toward said closed position so that said flexible cover hugs items held in said storage compartment.

9. The assembly of claim 8, wherein said flexible covering material is selected from a group of materials consisting of vinyl, leather, cloth or combinations thereof.

10. The assembly of claim 8, further including a slot in said trim panel adjacent said open side, said slot communicating with said recessed storage compartment.

11. The assembly of claim 8, wherein said recessed storage compartment and said flexible cover are trapezoidal in shape.

12. The assembly of claim 8, wherein said open side is oriented toward a rear of the motor vehicle.

13. The assembly of claim 8, wherein said expandable sidewall has a pleated construction.

14. The assembly of claim 1, wherein said flexible cover includes a substrate defining an open framework and an outer margin of said cover.

15. The assembly of claim 14, wherein said substrate includes a first side having a plurality of heat stakes for anchoring said substrate to said trim panel.

16. The assembly of claim 15, wherein said substrate includes two sidewalls extending from said first side, said sidewalls including a living hinge adjacent said first side.

17. The assembly of claim 16, wherein said expandable sidewall extends between said sidewalls of said substrate and said trim panel.

18. The assembly of claim 17, wherein said substrate includes an open side connecting said sidewalls of said substrate opposite said first side.

19. The assembly of claim 18, further including a band of elastic material connecting said cover to said trim panel adjacent said open side.

20. The assembly of claim 1, wherein said trim panel covers a vehicle pillar.
